(19) United States
(12) Patent Application Publication
(10) Pub. No.: US 2025/0269266 A1
(43) Pub. Date: Aug. 28, 2025

(54) SYSTEMS AND METHODS FOR METRIC EXTRACTION

(71) Applicant: STATS LLC, Chicago, IL (US)

(72) Inventor: Daniel Richard DINSDALE, Chicago, IL (US)

(73) Assignee: STATS LLC, Chicago, IL (US)

(21) Appl. No.: 19/042,388

(22) Filed: Jan. 31, 2025

Related U.S. Application Data
(60) Provisional application No. 63/559,042, filed on Feb. 28, 2024.

(51) Int. Cl. A63F 1/04; A63B 71/06

(52) U.S. Cl. CPC A63F 1/04; A63B 71/06; A63F 2001/0475

(57) ABSTRACT

Disclosed techniques relate to using machine learning for metric extraction of sports players in generating player content cards. In an example, a method for generating an interactive player ratings card may include receiving a plurality of event data comprising a plurality of real-time and historical player data. The method may further include extracting a plurality of player metric data associated with the plurality of event data. The method may further include aggregating the plurality of player metric data to determine one or more player ratings. The method may further include generating the interactive player ratings card including the one or more player ratings. The method may further include transmitting the interactive player ratings card to a user device.

### CROSS-REFERENCE TO RELATED APPLICATIONS

This application claims the benefit of priority to U.S. Provisional Application No. 63/559,042, filed Feb. 28, 2024, which is incorporated by reference in its entirety.

### TECHNICAL FIELD

Various embodiments of the present disclosure relate generally to sports applications and, more specifically, but without limitations, using machine learning for metric extraction of sports players in generating player content cards.

### INTRODUCTION

Cricket is a sport that is played in multiple formats. Many of the players play across formats, while some are specialized to play only a particular format. Understanding a player's skill against each aspect of the game becomes quite important for different purposes like scouting, team selection, fantasy points etc.

Unless otherwise indicated there, the materials described in this section are not prior art to the claims in this application and are not admitted to be prior art, or suggestions of the prior art, by inclusion in this section.

### SUMMARY OF THE INVENTION

In some embodiments, a method for generating an interactive player ratings card is described herein. A computing system receives a plurality of event data including a plurality of real-time and historical player data. One or more machine learning models extract a plurality of player metric data associated with the plurality of event data. The one or more machine learning models aggregate the plurality of player metric data to determine one or more player ratings. The one or more machine learning models generate the interactive player ratings card including the one or more player ratings. The computing system transmits the interactive player ratings card to a user device.

In some embodiments, a system for generating an interactive player ratings card is described herein. The system includes a memory storing instructions and a processor operatively connected to the memory and configured to execute the instructions. The operations include receiving a plurality of event data including a plurality of real-time and historical player data. The operations further include extracting a plurality of player metric data associated with the plurality of event data. The operations further include aggregating the plurality of player metric data to determine one or more player ratings. The operations further include generating the interactive player ratings card including the one or more player ratings. The operations further include transmitting the interactive player ratings card to a user device.

In some embodiments, a non-transitory computer-readable medium is described herein. The non-transitory computer-readable medium stories instructions that, when executed by one or more processors, perform operations. The operations include receiving a plurality of event data including a plurality of real-time and historical player data. The operations further include extracting a plurality of player metric data associated with the plurality of event data. The operations further include aggregating the plurality of player metric data to determine one or more player ratings. The operations further include generating an interactive player ratings card including the one or more player ratings. The operations further include and transmitting the interactive player ratings card to a user device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 depicts a block diagram illustrating a computing environment, according to example embodiments.

FIG. 2A depicts a flowchart of an exemplary method for generating a player content card, according to one or more embodiments.

FIG. 2B a flowchart of another exemplary method for generating a player content, according to one or more embodiments

FIG. 3 depicts extracted metric data and definitions for batting, according to example embodiments.

FIG. 4 depicts extracted metric data and definitions for bowling, according to example embodiments.

FIG. 5 depicts extracted metric data and definitions for fielding, according to example embodiments.

FIG. 6 depicts exemplary player cards, according to example embodiments.

FIG. 7 depicts exemplary player cards, according to example embodiments.

FIG. 8 depicts a flow diagram for training a machine-learning model, according to example embodiments.

FIG. 9A is a block diagram illustrating a computing device, according to example embodiments.

FIG. 9B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION OF EMBODIMENTS

Various aspects of the present disclosure relate generally to computer-implemented techniques for generating a player ratings cards. The player ratings cards may provide one or more player ratings generated in accordance with the techniques disclosed herein. In cricket, many players play across formats, while some are specialized to play only a particular format. Understanding a player's skill against each aspect of the game becomes important for different purposes like scouting, team selection, fantasy points, etc. Absolute ranking of a player based on a particular skill can provide diffused impressions. For example, in a T20 format, a player scoring most runs might not always be the best performing player. Disclosed herein is a player rating system that rates a player based on skill, also considering the complexity surrounding the situation of the game, performance, opposition, venue etc. needed to provide an absolute value of the player in a game situation.

Various embodiments of the present disclosure relate generally to machine learning for sports applications and, more specifically, but without limitations, using machine learning for metric extraction of sports players in generating player content cards. The player content cards may provide rating information in accordance with the techniques disclosed herein. The rating information may be generated and may be used to quantify the contribution (e.g., strengths, weaknesses, preferences, etc.) of that player. The rating may be calculated using a number of statistics, for example, runs scored, dismissals, opposing shots blocked, completed passes, interceptions, and the like. Therefore, the ratings may be generated for each player based on a comparison of other players.

Player ratings may be designed to keep intricacies of a game in consideration while providing each player with a percentile value that can help rank their skills against others who play the game. For example, an aspect may take ball-by-ball aggregated data and apply percentile ratings between 0-100 (e.g., 100 best players in the specific discipline) generating a percentile on the runs per ball of a batter or the percentile of variations bowled by a bowler. The rating system is defined for all skill sets (e.g., batter, bowler, fielder, wicket keeper, and all rounder) that a player can possess in the sport. The ratings may also consider additional information (e.g., player experience, quality of opposition, venue, etc.) to further define the percentiles, thus making sure each player can be differentiated based on their skillsets and strength/weaknesses. In addition to ratings, the system may also provide other labelled metrics defining favorable shots, favorable deliveries, preferences, strengths, weaknesses, and other subjective qualities of a player.

For example, labelling metrics describing a favorite shot is to take the percentage of runs scored across different shot type groups (e.g., 6% runs from sweep, 20% drive, etc.) and turn these all into percentiles. This may, for example, not identify the most used shot, but the most used shot in comparison to other players, providing insights into which shot a player utilizes more than their peers. A similar approach may be used for identifying favorite shot areas.

Additional labels (e.g., strengths and weaknesses) may be provided to compute ratings for various fame situations (e.g., percentile of a player's ratio of runs per ball against right-handed bowlers vs. left-handed bowlers). This rating is not then a measure of quality but preference towards left or right-handed bowling and can be categorized into a label (e.g., mild left-handed preference).

Each player rating may be determined using base level aggregated data, percentile ratings, and preference labels. Base level aggregate data may include a series of data for a specific category (e.g., batting strike rate, batting balls per six, etc.) See TABLE 1 below for additional base level aggregate data columns. The percentile ratings are determined over a single base level aggregate data column where a “higher is better” or “lower is better” may be used to determine a good or bad rating. For example, a “higher is better” label may be used for batting strike rate rating, whereas a “lower is better” label may be used for batting balls per six rating. See TABLE 2 for an example list of “higher is better” or “lower is better” rating categories. Preference labels may be used in player cards and are the group categories consistency of various internal ratings. In order to generate a label, a percentile of each target within a category (e.g., percentage of runs in 4 zones of the ground) and then take the highest rating. A preference may be given when the highest rating is above a threshold (e.g., 85) for that category, a medium preference may be given when a rating is between two thresholds (e.g., 85 and 65), and a mild preference may be given when a rating is below a threshold (e.g., 65).

For example, using TABLE 1, to determine the shot direction batting preference of Virat Kohli, the raw percentages for batting runs in each direction. As indicated in TABLE 1, batting_runs_straight_perc is 24.3, batting_runs_off_perc is 18.5, batting_runs_leg_perc is 32. 7, and batting_runs_behind_perc is 24.5. This data is then converted into a percentile (e.g., 0-100) rating which compare the percentage to all other batters in T20 cricket since 2019 and have faced at least 400 deliveries. See TABLE 1, columns batting_runs_straight_perc_batting_rating, batting_runs_off_perc_batting_rating, batting_runs_leg_perc_batting_rating, and batting_runs_behind_perc_batting_rating for conversion data. Upon determining the conversion data, a label can be given to the highest rating within the category (e.g., batting_runs_leg_perc_batting_rating of 71.749392936), based on the conversion data being between two threshold values (e.g., 86 to 65) a medium preference to leg side is given to Virat Kohli.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only.

Disclosed techniques are by no means limited to cricket specific sport. For example, the present aspects can be implemented for any sports or activities, such as for soccer, football, basketball, baseball, hockey, cricket, rugby, tennis, team sports, individual sports, and so forth.

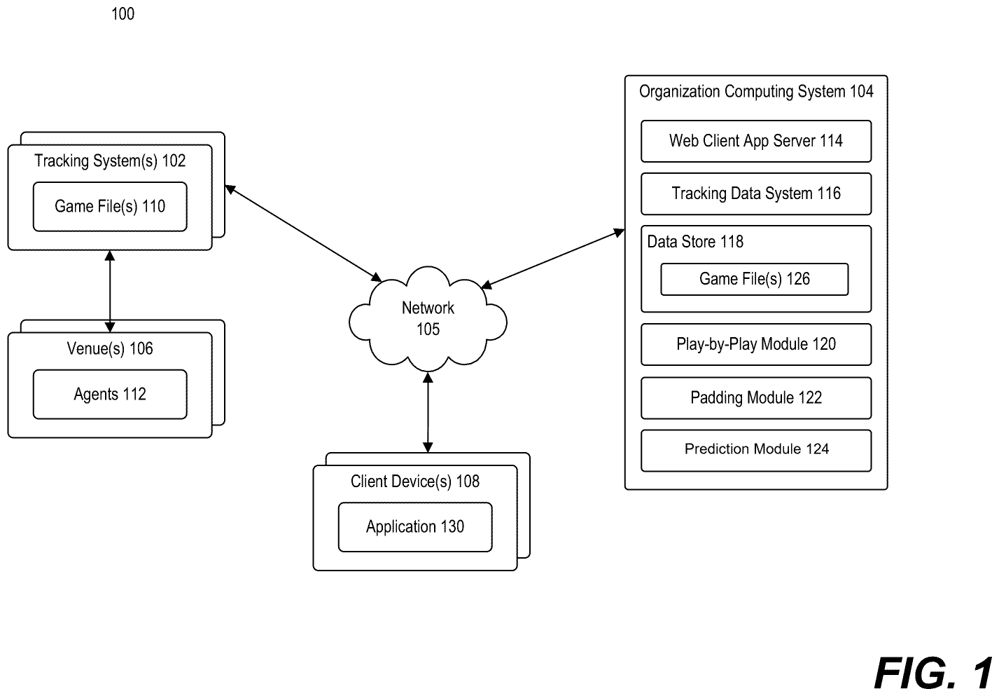

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of computing environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). Event data may be input via an event data input system and/or may be automatically identified using a machine learning model trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game and generate and/or predict player ratings values for one or more players. Organization computing system 104 may include at least a web client application server 114, tracking data system 116, data store 118, play-by-play module 120, padding module 122, and/or prediction module 124. Each of tracking data system 116, play-by-play module 120, padding module 122, and prediction module 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data and non-player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame. In some embodiments, tracking data system 116 may further determine non-player-tracking data using one or more techniques described herein. For example, non-player-tracking data may include information relating to each bowl (e.g., speed, rotation, ball flight, etc.) and field type (e.g., dirt, grass, location, etc.). In addition, the non-player-tracking data may be used with player-tracking data when determining player ratings and predicted player ratings as described herein.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for prediction module 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed. For example, play-by-play module 120 may receive video data from a broadcast video stream in a first format and convert the first format to a second format readable by the play-by-play module 120. The first format may include an information format (e.g., text, character strings, and/or video data) based on the manually inputted and/or automatically generated data. The second format may include a machine-readable format that may be provided as input to one or more machine-learning models. The second format may include, for example, a JSON file, XML file, or the like. The play-by-play module 120 may further convert data from the second format to a third format as box score data. The third format may include an information format (e.g., text, character strings, and/or video data) based on the automatically generated data from the play-by-play module 120.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

Prediction module 124 may be configured or trained to generate and/or predict player ratings values for each player. For example, prediction module 124 may be configured to receive the foregoing features (e.g., rookie priors, time series data points, player position data, box score data, play-by-play data, player-tracking data, non-player-tracking data, and the like) as inputs and run the inputs through gradient-boosted decision trees to generate a player ratings value for each player. Using the player ratings value, prediction module 124 may take each statistical output and predict a player's ratings value for future actions (e.g., matches, tournaments, events, etc.). The prediction module 124 may output a generated player ratings value and a predicted player ratings value for one or more metrics (e.g., consistency, power hitting, shot category, or the like), see TABLE 1 and TABLE 2. In addition, the prediction module 124 may generate a comparison player ratings using the non-player-tracking data. For example, a user may want to compare bowlers for an upcoming match. The prediction module 124 may generate a predicted player ratings value for each bowler based on player-tracking data and non-player-tracking data as described herein. The player-tracking data may include number of bowls per match, number of strikes, or the like. The non-player-tracking data may include information relating to each bowl (e.g., speed, rotation, ball flight, etc.) and field type (e.g., dirt, grass, location, etc.). If the upcoming match is played on a harder dirt field (e.g., bowls may bounce/roll more), the prediction module 124 may determine the bowling style of one team may benefit from the field type and predict higher player ratings values for a number of players.

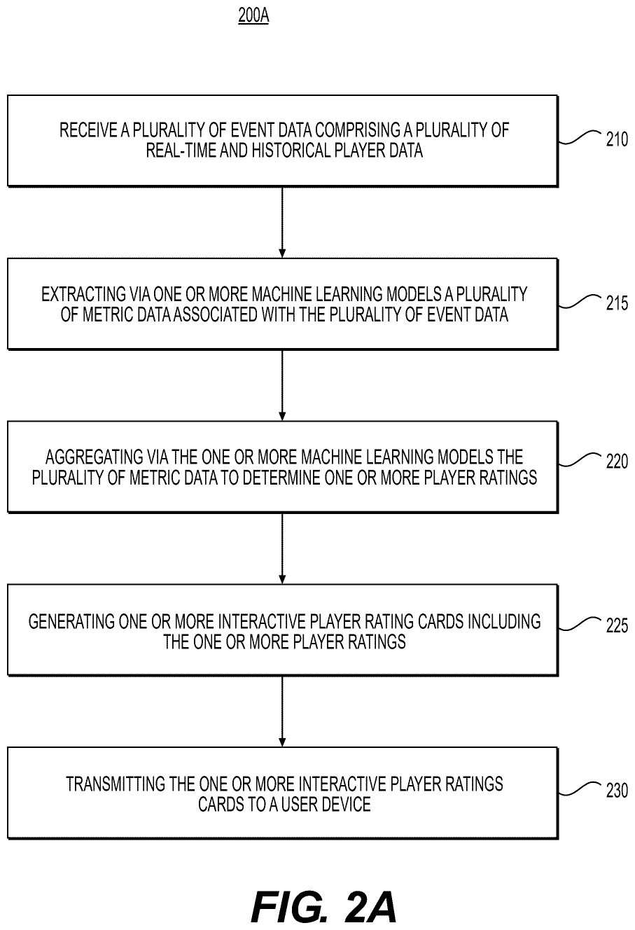

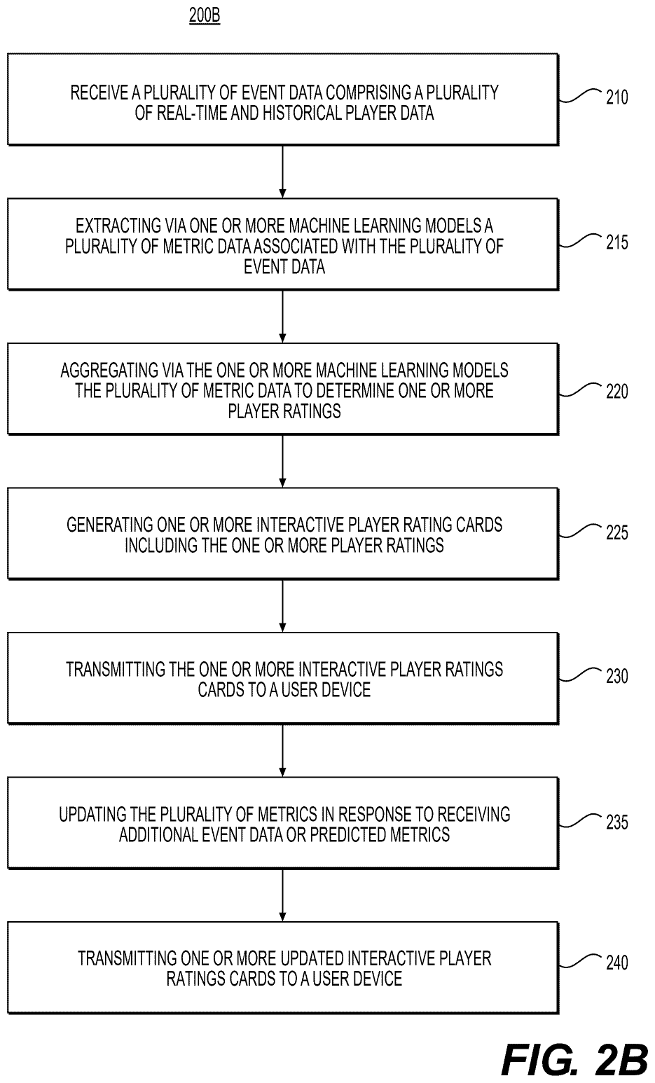

In some embodiments, prediction module 124 may include a separate prediction model tuned for each player. Given that all players are very different from each other, there are times that a prediction model may have trouble projecting their abilities. In such scenarios, projections from prediction module 124 may be compared with real-world or actual statistics. Using Steph Curry, for example, if prediction module 124 generates a three-point percentage for Curry that is below Curry's average three-point percentage, an operator may adjust the weights of Curry's individualized prediction model. Prediction module 124 is discussed further in conjunction with figures discussed below (e.g., FIGS. 2A, 2B, and 6-7).

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to access one or more player ratings values generated by the prediction module 124. The content that is displayed to client device 108 may be transmitted from web client application server 114 to client device 108, and subsequently processed by application 130 for display through a graphical user interface (GUI) of client device 108.

### Example Prediction Engine

An example prediction engine (e.g., which may be part of a tracking data system) may be configured to predict an underlying formation of a team. Mathematically, the goal of a role-alignment procedure may be to find the transformation A: {U₁, U₂, . . . , Uₙ}×M→[R₁, R₂, . . . , R_{K}], which may map the unstructured set U of N player trajectories to an ordered set (e.g., a vector) of K role-trajectories R. Each player trajectory itself may be an ordered set of positions Uₙ=[x_{s,n}]ₛ₌₁^{S} for an agent n∈[1, N] and a frame s∈[1, S]. In some embodiments, M may represent the optimal permutation matrix that enables such an ordering. The goal of the prediction module 124 may be to find the most probable set of [symbol] of two-dimensional (2D) probability density functions:

$${ℱ}^{*} = arg {max}_{ℱ} P ( ℱ \vert R ) \\ P ( x ) = {\sum }_{n = 1}^{N} P ( x \vert n ) P ( n ) = \frac{1}{N} {\sum }_{n = 1}^{N} {P}_{n} ( x )$$

In some embodiments, this equation may be transformed into one of entropy minimization where the goal is to reduce (e.g., minimize) the overlap (e.g., the KL-Divergence) between each role. As such, in some embodiments, the final optimization equation in terms of total entropy H may become:

$${ℱ}^{*} = arg {max}_{ℱ} {\sum }_{n = 1}^{N} H ( x \vert n )$$

The prediction engine may include a formation discovery module, a role assignment module, a template module, and/or the like each corresponding to a distinct phase of the prediction process. The formation discovery module may be configured to learn the distributions which maximize the likelihood of the data. The role assignment module may be configured to map each player position to a “role” distribution in each frame. Once the data has been aligned, the template module may be configured to map each learned formation a formation cluster template.

An organization computing system may receive tracking data and/or event data for a plurality of events across a plurality of seasons or across a match. For each event, the pre-processing agent may divide the event into a plurality of segments based on the event information. In some embodiments, the pre-processing agent may divide the event into a plurality of segments based on various events that may occur throughout the game. For example, the pre-processing agent may divide the event into a plurality of segments based on one or more events that include, but may not be limited to, red cards, ejections, technical fouls, flagrant fouls, player disqualifications, substitutions, halves, periods, quarters, overtime, and the like. Generally, each segment of a plurality of segments associated with an event may include an interval of a requisite duration (e.g., at least one minute of play, at least two minutes of play, etc.). Such requisite duration may allow an organization computing system to detect a team's formation.

Each segment may include a set of tracking data associated therewith. The player tracking data may be captured by tracking system, which may be configured to record the (x, y) positions of the players at a high frame rate (e.g., 10 Hz). In some embodiments, the player tracking data may further include single-frame event-labels (e.g., pass, shot, cross) in each frame of player tracking data. These frames may be referred to as “event frames.” As shown, the initial player tracking data may be represented as a set U of N player trajectories. Each player trajectory itself may be an ordered set of positions Uₙ=[x_{s,n}]ₛ₌₁^{S} for an agent n∈[1, N] and a frame s∈[1, S].

In some embodiments, the pre-processing agent may normalize the raw position data of the players. For example, the pre-processing agent may normalize the raw position data of the players in each segment so that all teams in the player tracking data are attacking from left to right and have zero mean in each frame. Such normalization may result in the removal of translational effects from the data. This may yield the set U′={U₁′, U₂′, . . . , Uₙ′}.

In some embodiments, the pre-processing agent may initialize cluster centers of the normalized data set for formation discovery with the average player positions. For example, average player positions may be represented by the set μ₀={μ₁, μ₂, . . . , μ₃}. The pre-processing agent may take the average position of each player in the normalized data and may initialize the normalized data based on the average player positions. Such initialization of the normalized data based on average player position may act as initial roles for each player to minimize data variance.

An organization computing system may learn a formation template from the tracking data for each segment. For example, the formation discovery module may learn the distributions which maximize the likelihood of the data. The formation discovery module may structure the initialized data into a single (SN)×d vector, where S may represent the total number of frames, N may represent the total number of agents (e.g., ten outfielders in the case of soccer, five players in the case of basketball, fifteen players in the case of rugby, etc.) and d may represent the dimensionality of the data (e.g., d=2).

The formation discovery module may then initiate a formation discovery algorithm. For example, the formation discovery module may initialize a K-means algorithm using the player average positions and execute to convergence. Executing the K-means algorithm to convergence produces better results than conventional approaches of running a fixed number of iterations.

The formation discovery module may then initialize a Gaussian Mixture Model (GMM) using cluster centers of the last iteration of the K-means algorithm. By parametrizing the distribution as a mixture of K Gaussians (with K being equal to the number of “roles,” which is usually also equal to N, the number of players), the formation discovery module may be able to identify an optimal formation that maximizes the likelihood of the data x. In other words, GMM may be configured to identify [symbol] ={P₁, P₂, . . . , P_{K}}, where [symbol] may represent the optimal formation that maximizes the likelihood of the data x. Therefore, instead of stopping the process after the last iteration of the K-means algorithm, the formation discovery module may use GMM clustering, as the ellipse may better capture the shape of each player role compared to only a K-means clustering technique, which captures the spherical nature of each role's data cloud.

Further, GMMs are known to suffer from component collapse and become trapped in pathological solutions. Such collapse may result in non-sensible clustering, e.g., non-sensical outputs that may not be utilized. To combat this, the formation discovery module may be configured to monitor eigenvalues (λᵢ) of each of the components or parameters of the GMM throughout the expectation maximization process. If the formation discovery module determines that the eigenvalue ratio of any component becomes too large or too small, the next iteration may run a Soft K-Means (e.g., a mixture of Gaussians with spherical covariance) update instead of the full-covariance update. Such process may be performed to ensure that the eventual clustering output is sensible. For example, the formation discovery module may monitor how the parameters of the GMM are converging; if the parameters of the GMM are erratic (e.g., “out of control”), the formation discovery module may identify such erratic behavior and then slowly return the parameters back within the solution space using a soft K-means update.

It will be understood that a prediction engine and/or related components may be implemented using techniques alternative or in addition to those described herein.

### Hash-Table/Playbook Learning

For retrieval tasks using large amounts of data, an example embodiment of the system uses a hash-table is required by grouping similar plays together, such that when a query is made, only the “most-likely” candidates are retrieved. Comparisons can then be made locally amongst the candidates and each play in these groups are ranked in order of most similar. Previous systems attempted clustering plays into similar groups by using only one attribute, such as the trajectory of the ball. However, the semantics of a play are more accurately captured by using additional information, such as information about the players (e.g., identity, trajectory, etc.) and events (pass, dribble, shot, etc.), as well as contextual information (e.g., if team is winning or losing, how much time remaining, etc.). Thus, embodiments of the present system utilize information regarding the trajectories of the ball and the players, as well as game events and contexts, to create a hash-table, effectively learning a “playbook” of representative plays for a team or player's behavior. The playbook is learned by choosing a classification metric that is indicative of interesting or discriminative plays. Suitable classification metrics may include predicting the probability of scoring in soccer or basketball (e.g., expected point value (“EPV”), or expected goal value (“EGV”). Other predicted values can also be chosen for performance variables, such as probability of making a pass, probability of shooting, probability of moving in a certain direction/trajectory, or the probability of fatigue/injury of a player.

The classification metric is used to learn a decision-tree, which is a coarse-to-fine hierarchical method, where at each node a question is posed which splits the data into groups. A benefit of this approach is that it can be interpretable and is multi-layered, which can act as “latent factors.”

### Example Bottom-Up Approach

In an embodiment of the system, an example bottom-up approach to learning the decision tree is used. Various features are used in succession to discriminate between plays (e.g., first use the ball, then the player who is closest to the ball, then the defender etc.). By aligning the trajectories, there is a point of reference for trajectories relative to their current position. This permits more specific questions while remaining general (e.g., if a player is in the role of “point guard”, what is the distance from his/her teammate in the role of “shooting guard”, as well as the distance from the defender in the role of “point guard”). Using this approach avoids the need to exhaustively check all distances, which is enormous for both basketball and soccer. Example Top-Down Approach

In another embodiment of the system, an example top-down approach to learning the decision tree is used. At a first step, all the plays are aligned to the set of templates. From this initial set of templates, the plays are assigned to a set of K groups (clusters), using all ball and player information, forming a Layer 1 of the decision tree. Back propagation is then used to prune out unimportant players and divide each cluster into sub-clusters (Layer 2). The approach continues until the leaves of the tree represent a dictionary of plays which are predictive of a particular task—e.g., goal-scoring (Layer 3).

### Personalization Using Latent Factor Models

In addition to raw trajectory information, in embodiments of the system, the plays in the database are also associated with game event information and context information. The game events and contexts in the database for a play may be inferred directly from the raw positional tracking data (e.g., a made or missed basket), or may be manually entered. Role information for players (can also be either inferred from the positional tracking data or entered separately. In embodiments of the system, a model for the database can then be trained by crafting features which encode game specific information based on the positional and game data and then calculating a prediction value (between 0 and 1) with respect to a classification metric (e.g., expected point value).

If there are a sufficient number of examples, the database model can be personalized for a particular player or game situation using those examples. In practice, however, a specific player or game situation may not be adequately represented by plays in the database. Thus, embodiments of the system find examples which are similar to the situation of interest-whether that be finding players who have similar characteristics or teams who play in a similar manner. A more general representation of a player and/or team is used, whereby instead of using the explicit team identity, each player or team is represented as a distribution of specific attributes. Embodiments of the system use the plays in the hash-table/playbook that were learned through the distributive clustering processes described above.

Further, while various aspects are discussed with respect to a single sport, such aspects are described are merely illustrative examples. Disclosed techniques are by no means limited to any sport in particular. For example, the present aspects can be implemented for other sports or activities, such as soccer, football, basketball, baseball, hockey, cricket, rugby, tennis, and so forth.

FIG. 2A illustrates an exemplary method 200A for generating an interactive player ratings card. Exemplary method 200A begins with step 210, wherein a plurality of event data comprising a plurality of real-time and historical player data are received (e.g., by organization computing system 104 as depicted in FIG. 1). The plurality of real-time and historical player data may include one or more player metrics, for example, consistency, power hitting, favorite run scoring area, favorite scoring shots, or the like. The plurality of real-time and historical player data may be received from automatically generated tracking data and/or event data that is generated based on in-venue or broadcast feeds. For example, tracking data system 116 may be configured to receive information from tracking system 102 location within venue 106 and/or in communication with components within venue 106. The information received may be utilized by tracking data system 116 to automatically generate tracking data and/or event data.

At step 215, a plurality of metric data associated with the plurality of event data are extracted. The event data may be extracted by one or more trained machine learning models. The one or more machine learning models may be trained to identify event data within sports tracking data received from the tracking data system 116, game files 126, and/or play-by-play module 120. The extracted event data may be associated with one or more corresponding players and stored accordingly. In addition, step 215 may convert tracking data (as disclosed herein) or video feed data (e.g., from in-venue cameras or drones) into digital versions of the data that identifies player positions and/or object (e.g., ball, wicket, etc.) positions, identifying changes in positions (e.g., of players, objects, etc.) to identify movement and trends. For example, for each bowl the ball may be tracked to identify ball speed, spin, position, or the like and associate the identified information with the player (e.g., bowler and batter). The identified ball speed, spin, and position, may be included with the event data for each bowl and/or hit, associating with each player involved (e.g., bowler, batter, fielder(s)). In one embodiment, the event data may be extracted manually, for example, each event data item may be collected by one or more trained experts. The collected event data may be utilized by the one or more machine learning models as similarly described herein.

At step 220, the plurality of metric data may be aggregated to determine one or more player ratings. The one or more player ratings may include generating player ratings and/or predicted player ratings. The generated player ratings may include a player rating based on real-time and/or historical event data. Event data may be inputted into one or more models to generate the one or more player ratings. The one or more models may compare the inputted event data associated with a player to that player's historical event data and to other players (e.g., based on positions) by isolating when another player is playing a position that corresponds to the rating for a given player (e.g., compare player 1 (bowler) to other players when they bowl). Isolating a player by position will require a determination of when a player is bowling versus fielding in a single match. This determination may exclude player information relating to when the player is in a different position (e.g., fielding). Once determined, event data relating to the player position may be identified and used by the one or more models to determine the player ratings for that particular position.

In addition to determining player ratings based on percentiles, as described above, the one or more machine learning models may be used to generate player ratings by predicting the outcome of a particular event (e.g., delivery in cricket), based on one or more factors (e.g., batter, bowler, venue, etc.). The one or more machine learning models may be trained to predict the outcome of the delivery (e.g. predict runs scored off a delivery based on the player ratings of the bowler and batter), and the one or more machine learning models may be adjusted based on the outcome of the delivery. For example, if a player continually under-performs with respect to their player ratings, a reduction in value of one or more player ratings may occur. Accordingly, an initial rating may be generated and may be compared to new player performance. Based on the comparison, an updated, refined, rating may be output by the one or more machine learning models. The machine learning models may also extend ratings for players with fewer data points. For example, based on the ability of the batter against right handed bowlers, the one or more machine learning models may be trained to predict the batter's player ratings against left handed bowlers even when there are fewer data points related to this category.

In addition, category specific player ratings may be determined at step 215. Category specific player ratings may be based on the category of an event by analyzing given event data based on a category type. Categories may include pitch/field type (e.g., grass pitch, green pitch, flat track pitch, wet pitch, dusty pitch, dead pitch dry pitch, or the like) or match type (e.g., test matches, One-Day Internationals (ODIs), Twenty20 (T20) matches, and T10 matches). For example, as described above, non-player-tracking data may be determined as part of the event data from tracking system 102 and tracking data system 116. The event data and/or tracking data may be analyzed by a machine learning model trained to classify the event data and/or tracking data, using a classification algorithm, where the classification may output a category associated with the tracking data and/or event data (e.g., pitch/field type, match type, etc.). The non-player-tracking data may relate to one or more categories and may be used to determine the one or more player ratings for a specified category. One or more player ratings may be generated based on the selected or determined category.

The predicted player ratings may include a player rating based on predicted values for each metric for an upcoming match, tournament and/or series. The predicted player ratings may be generated by the prediction module 124 as described herein. For example, prediction module 124 may receive player data (e.g., rookie priors, time series data points, player position data, box score data, play-by-play data, and the like) as inputs and run the inputs through gradient-boosted decision trees to generate one or more player ratings. Using the player ratings, prediction module 124 may take each statistical output and predict a player's ratings for future actions (e.g., matches, tournaments, events, etc.). As similarly described above with respect to generating player ratings, generating predicted player ratings may be determined in a similar manner. For example, to determine one or more predicted player ratings, event data associated with a player may be used as a comparison to other players of the same position. In addition, generating predicted category specific ratings may be determined as similarly described above.

At step 225, one or more interactive player rating cards is generated that includes at least the one or more player ratings, a graphical image of the player, and/or a graphical representation associated with the one or more player ratings. In examples, the interactive player ratings card is generated in real-time as the plurality of real-time event data is received. Real-time, as used herein, may correspond to within five minutes of an event or action being taken (e.g., a run scored). The interactive player ratings cards may be generated according to a set of ordering rules. In examples, the ordering rules may include a first ordering rule. The first ordering rule may include displaying a first player rating unique to the skill above a second player rating in the interactive player ratings card based on the first player rating including a higher priority value relative to the second player rating. Further the interactive player ratings card may be configured to be filtered according to one or more of the player ratings per skill or desired player rating per user request. At step 230, the interactive player ratings card may be transmitted to a user interface (e.g., via network 105 to a display of client device 108 via application 130, as depicted in FIG. 1).

FIG. 2B illustrates an exemplary method 200B for generating an interactive player ratings card. It should be appreciated that exemplary method 200B may perform substantially similar steps as exemplary method 200A shown and described above. Exemplary method 200B may include substantially similar steps as exemplary method 200A except for the difference explicitly described herein. Exemplary method 200B may perform step 210, step 215, step 220, step 225, and step 230 as described above with reference to FIG. 2A.

At step 235, additional event data and/or predicted metrics may be received (e.g., by organization computing system 104 as depicted in FIG. 1) and utilized to update the plurality of metrics. The additional event data may include real-time event data generated from a live event or match. For example, as described above, tracking data system 116 may be configured to receive broadcast data from tracking system 102 and generate tracking data from the broadcast data. In doing so, tracking data system 116 may detect and track players and objects (e.g., blows, hits, runs, or the like) to identify one or more events. In addition, play-by-play module 120 may assist tracking data system 116 in automatically detecting events. Each detected event may be used to update the plurality of metric data in real-time or substantially real-time. As described with respect to FIG. 2A, event data may include category specific events. The category specific events may be determined using tracking system 102 and/or tacking data system 116. For example, category specific ratings (e.g., pitch/field type) may be determined and modified throughout an event or match. At the beginning of the match, the pitch/field may be determined to be dry grass. However, upon collecting event data from one or more bowls, tracking data system 116 may determine that the pitch/field is acting more like a wet grass pitch based on the non-player-tracking data (e.g., ball speed, spin rate, bounce patterns, etc.). Accordingly, event data may be received and updated according to the additional information. At step 240, the updated interactive player ratings card may be transmitted to a user interface (e.g., via network 105 to a display of client device 108 via application 130, as depicted in FIG. 1).

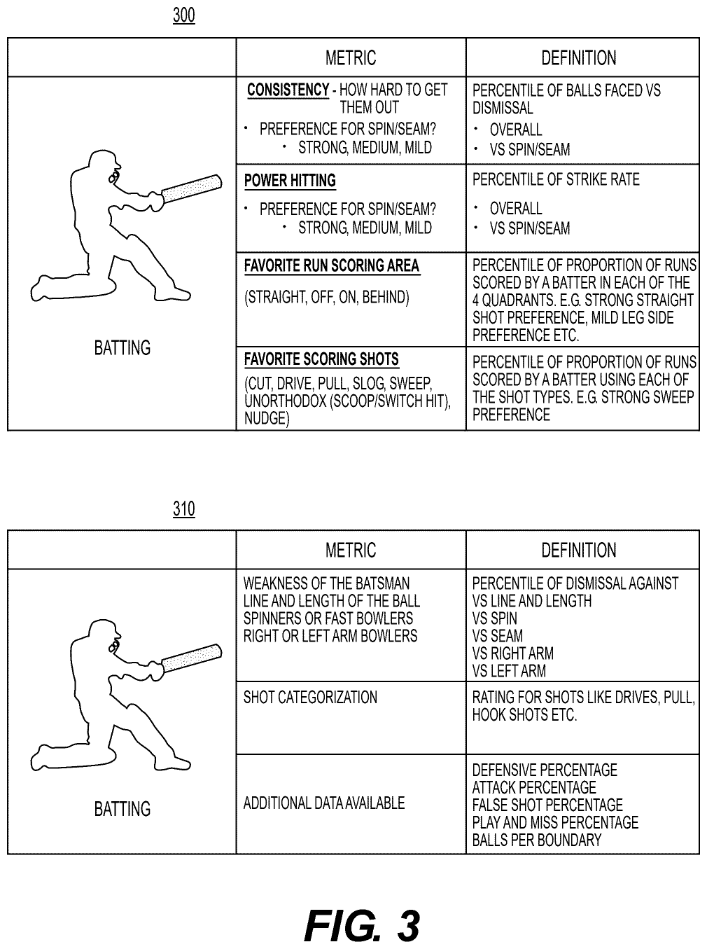

FIGS. 3-5 depict the extracted metric data and definitions for one or more statistics (e.g., batting, bowling, and fielding) according to one or more aspects of the disclosed subject matter. For example, FIG. 3 depicts metrics 300 relating to batting (e.g., consistency, power hitting, favorite run scoring area, and favorite scoring shots) and definitions relating to each metric (e.g., percentile of balls faced vs dismissal, percentile of strike rate, and percentiles of proportion of runs scored by a batter). FIG. 3 further depicts additional metrics 310 relating to batting (e.g., weakness of the batsman, line and length of the ball, spinners or fast bowlers, etc.) along with definitions relating to each additional metric (e.g., percentile of dismissal against, rating for types of shots, defensive percentile, etc.). Each of the metrics (e.g., consistency, power hitting, or the like) may be extracted from a plurality of event data, where the event data may include sports tracking data, play-by-play data, or the like as described above with respect to tracking data system 116, game files 126, play-by-play module 120, and/or padding module 122. For example, the metric “favorite run scoring area” may be determined using event data associated with a plurality of sports tracking data from one or more broadcast feeds. Each data point (e.g., event data) may be determined based on extracted information relating to a player at bat and each of their respective scoring positions. Each of the data points may be extracted from a first format usable by the tracking data system 116 to a second format usable by the one or more machine learning models to aggregate each data point to determine one or more overall metrics (e.g., favorite run scoring area).

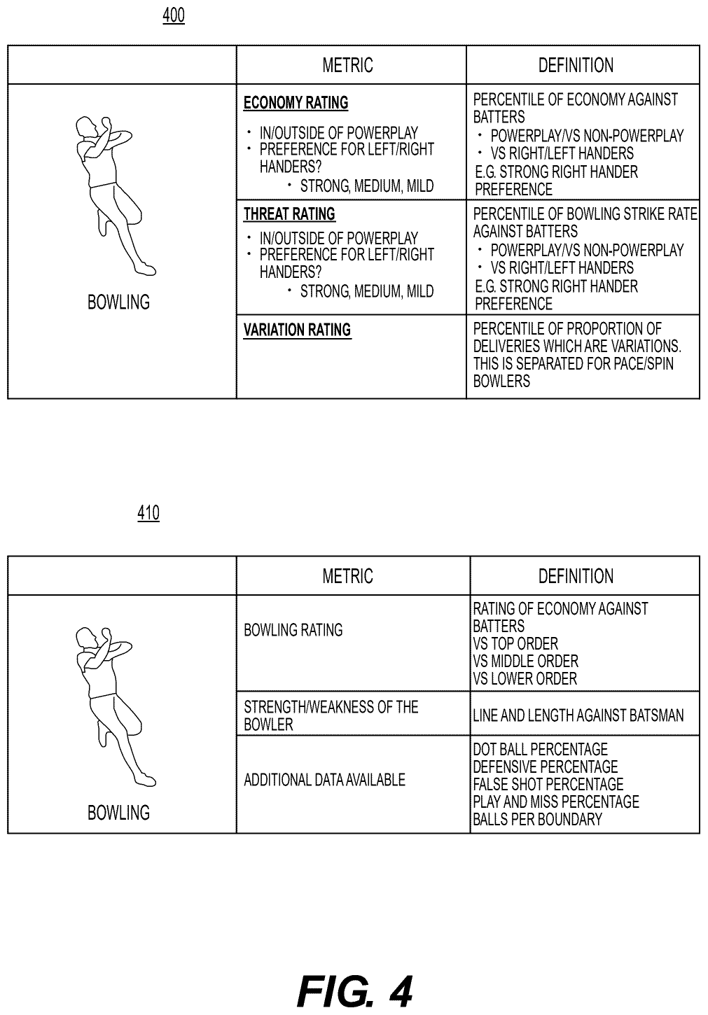

FIG. 4 depicts metrics 400 relating to bowling (e.g., economy rating, threat rating, variation rating, etc.) and definitions relating to bowling (e.g., percentile of economy against batters, percentile of bowling strike rate, percentile of proportion of deliveries, etc.). FIG. 4 further depicts additional metrics 410 relating to bowling (e.g., bowling rating, strength/weakness of bowler, etc.) and definitions relating to each additional bowling metric (e.g., rating of economy against batters, line and length against batsmen, bot ball percentage, etc.) relating to bowling.

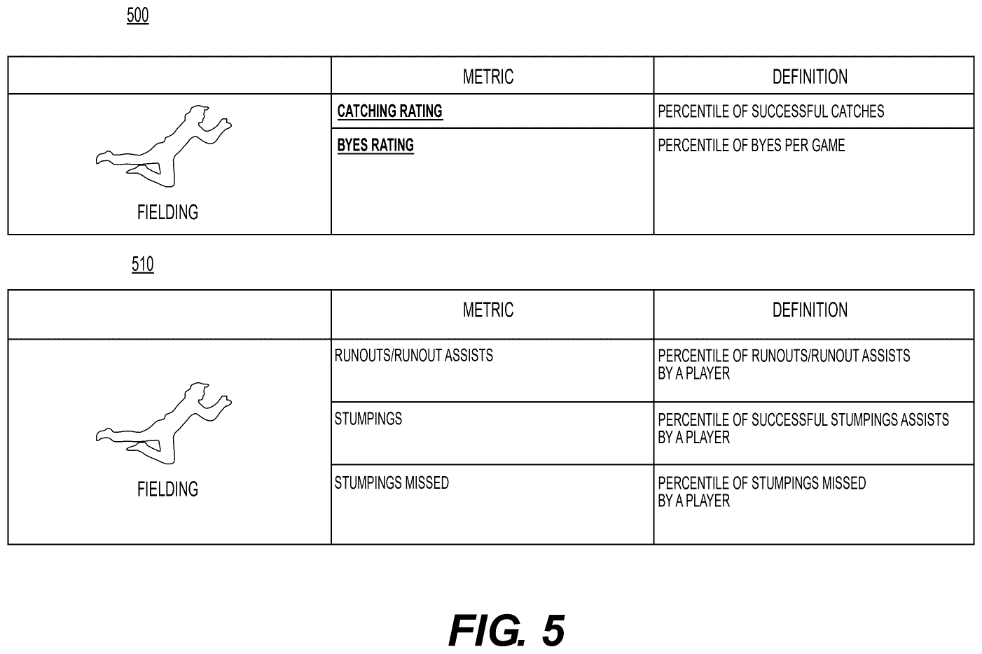

FIG. 5 depicts metrics 500 relating to fielding (e.g., catching rating, byes rating, etc.) along with definitions (e.g., percentile of successful catches, percentile of byes per game, etc.). FIG. 5 further depicts additional metrics 510 relating to fielding (e.g., runouts and assists, stumping, stumpings missed, etc.) and definitions relating to each of the additional metrics (e.g., percentile of runouts and assists, percentile of successful stumpings, percentile of stumpings missed, etc.) relating to fielding.

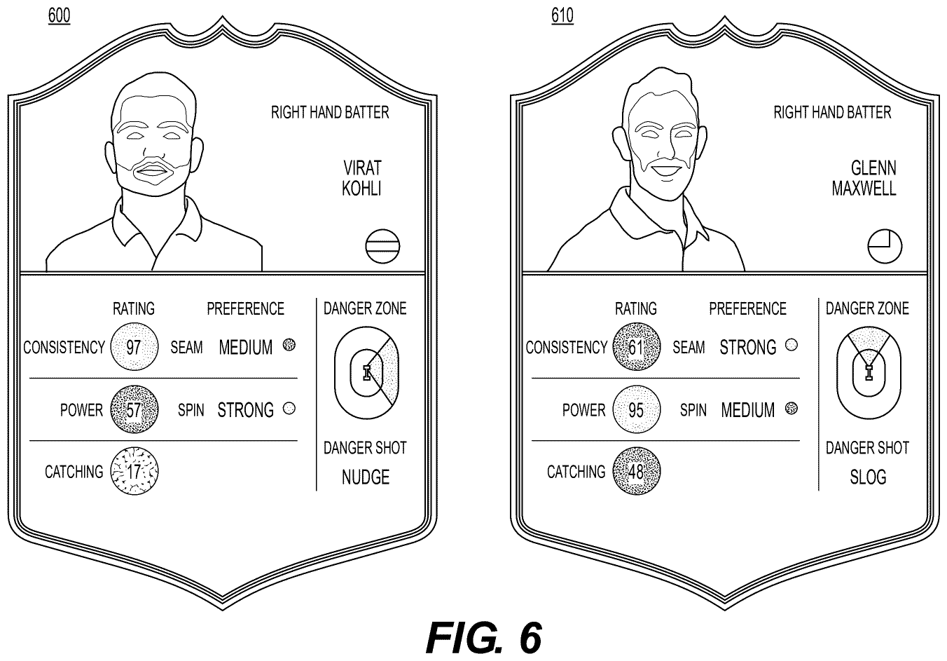

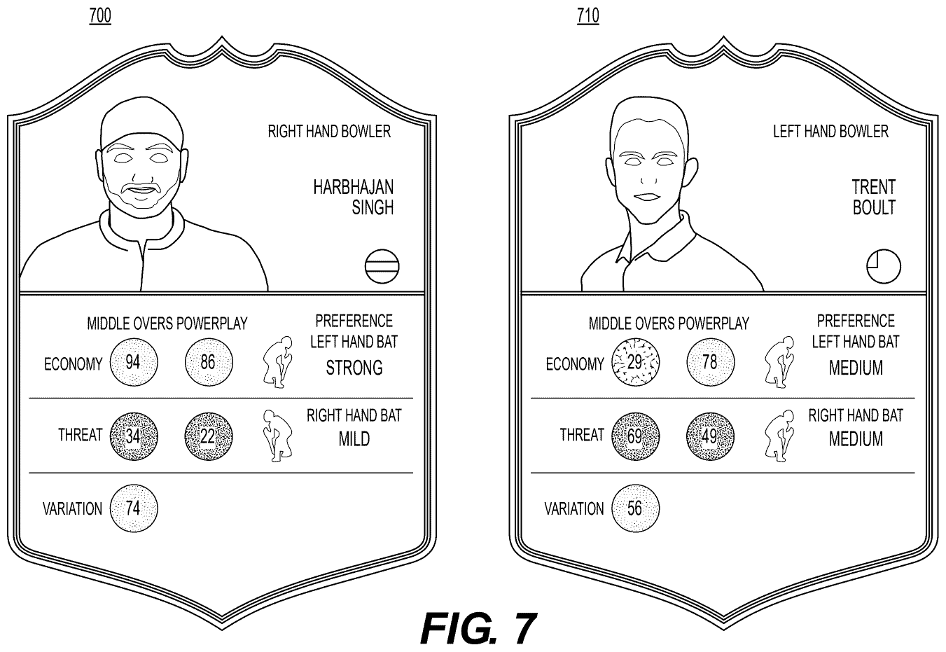

FIGS. 6-7 depict exemplary player cards, according to one or more aspects of the disclosed subject matter. Each player card may include a plurality of ratings, preferences, and labels. Each of the ratings, preferences, and labels may be color coded to indicate a range of rating (e.g., red for values between 0-30, yellow for values between 31-70, and green for values between 71-100) corresponding to the number or percentage displayed. For example, as depicted in player card 600, a color coding of red, yellow, and green may be used. The “catching” metric may be colored red, the “power” metric may be yellow, and the “consistency” metric may be green. For some player metrics, a higher number is better and for other player metrics a lower number is better. Each player metric may correspond to a color code based on the metric being a certain quality. Additional combinations with respect to the number of ranges and corresponding colors may be utilized to express the player metric and the quality of each player metric.

FIG. 6 depicts exemplary player cards with player ratings. Player card 600, may indicate the player being a right-handed batter with a plurality of ratings along with a player image. The player card 600 may include player ratings and preferences along with a graphic for danger zone batting statistics. Player card 600 may include a player consistency rating of 97, power rating of 57, and a catching rating of 17. The player card 600 may indicate the player has a medium preference for seam bowls and a strong preference for spin bowls with a danger zone area graphic and danger shot of nudge.

Player card 610 may include a consistency rating of 61, power rating of 95, and a catching rating of 48. The player card 610 may include a strong preference for seam bowls and a medium preference for spin bowls with a danger zone area graphic and danger shot of slog. Additional player ratings may be determined and presented within a player card (e.g., 600). The additional player ratings may include, but are not limited to, clutch, weakness, location based player ratings, and/or fielding ratings.

Clutch player ratings may include a performance under pressure, where particular high value game event data may be analyzed. Clutch player ratings may be generated based on identifying high value game event data. A machine learning model may classify event data as high value or low value based on high value criteria (e.g., type of event, time remaining in an event or subset of event, closeness in score, and/or the like or a combination thereof). Alternatively, or in addition, the machine learning model may output high value game events based on correlating excitement data for a plurality of events (e.g., determined based on audio properties associated with the plurality of events). Game events that meet an excitement threshold (e.g., based on an excitement score) may be designated high value game events. One or more machine learning models may output a clutch player rating based on isolating high value game events from other game events and determining a rating based on the isolated high value game events.

Weakness player ratings may include specific areas of the game in which the player is weak. Weakness player ratings may be generated based on identifying event data where a player receives a low value. A machine learning model may classify event data as low value based on low value criteria (e.g., type of event, missed opportunities, continuous failed attempts, and/or the like or a combination thereof). Alternatively, or in addition, the machine learning model may output low value game events based on correlating disappointment data for a plurality of events (e.g., determined based on audio properties associated with the plurality of events). Game events that meet a disappointment threshold (e.g., based on a disappointment score) may be designated low value game events. One or more machine learning models may output a weakness player rating based on isolating low value game events from other game events and determining a rating based on the isolated low value game events. In addition, a weakness player ratings may incorporate a large number of aggregates such as weakness in specific countries/competitions, or against specific opposition players who consistently get the better of that particular player.

Location based player ratings may include a breakdown of player ratings based on where and/or how a ball bounces on a bowl. For example, the machine learning models may determine different locations of where the ball bounces with respect to how the player performs (e.g., hits) based on the variety of bowls and their respective bounces. As described herein, tracking data system 116 may determine the properties of a bowl (e.g., speed, rotation, ball flight, etc.) based on the received tracking data (e.g., tracking system 102 and/or broadcast feed data). This information may indicate how the ball may bounce relative to the bowl with respect to the field properties (e.g., grass vs. dirt, dry vs. wet, etc.). Additional event data may be generated based on the tracking information associated with the bowl, ball, and/or field to be used when generating player ratings.

The additional fielding ratings may include a player ratings addressing how efficient a player is at preventing opposition runs by stopping the ball in the outfield. For example, tracking data system 116 may determine event data relating to a hit after a delivery. The event data may include one or more of time information relating to the bowl and the hit, the speed of the ball after being hit, time information relating to when the ball was stopped, or the like. One or more machine learning models may compare this information with other similar event data to determine how this event compares to others. This information may provide an overall efficiency of a particular player in addition to an efficiency of a particular player versus an opposing player. The player ratings described herein are not exhaustive, one having ordinary skill in the art may include any additional player ratings based on the collected event data.

FIG. 7 depicts exemplary player cards, according to one or more aspects of the disclosed subject matter. For example, player card 700 depicts a right-handed bowler with a plurality of ratings along with a player image. The player ratings may include middle overs, power plays, and player preferences. Player card 700 may include an economy rating of 94, a threat rating of 34, and a variation rating of 74. Player card 700 may include a powerplay rating of 86 and a threat rating of 22 with a strong preference to left-handed batters and a mild preference to right-handed batters.

Another example, player card 710 depicts a left-handed bowler with a plurality of ratings along with a player image. Player card 710 may include an economy rating of 29, a threat rating of 69, and a variation rating of 56. Player card 710 may include a powerplay rating of 78 and a threat rating of 49 with a medium preference to left-handed batters.

Another example, player card 720 depicts a right-handed bowler with a plurality of ratings along with a player image. Player card 720 may include an economy rating of 73, a threat rating of 8, and a variation rating of 67. Player card 720 may include a powerplay rating of 56 and a threat rating of 43 with a medium preference to left-handed batters and a mild preference to left-handed batters.

The player cards as described above with respect to FIGS. 6-7 above, may display player ratings based on an aggregation of each player over a period of time. Each player card may include a pre-determined template of player ratings for display based on the player position and available metrics. In addition, player cards (e.g., 600, 610, 700, 710, and 720) may include predicted player ratings using predicted metrics. For example, prediction module 124 may receive player data (e.g., rookie priors, time series data points, player position data, box score data, play-by-play data, and the like) as inputs and run the inputs through gradient-boosted decision trees to generate one or more player ratings. Using the player ratings, prediction module 124 may take each statistical output and predict a player's ratings for future actions (e.g., matches, tournaments, events, etc.). Each player card may present predicted player ratings based on an upcoming match or tournament.

In addition, the player cards (e.g., 600, 610, 700, 710, and 720) may be interactive allowing each user to select the one or more player ratings for display. For example, a user may wish to display more or less player ratings than provided. A user may select a player rating and be presented with one or more available player ratings for display (not shown). The user may select the one or more available player ratings for inclusion and display on the player card. Each of the one or more player ratings may include a combination of aggregated player ratings and predicted payer ratings.

FIGS. 3-7 may be based on, for example a core player database which may be populated based on historical match data, sports tracking data, event data, and/or broadcast feed data as described above. For example, the content shown in FIGS. 3-7 may be populated based on match data starting from the 1975 World Cup season. Over time, more leagues and players may be added to the core player database to provide a comprehensive record of current players worldwide. Such data or feeds based on such data allows users to trace a player's career across multiple seasons. For example, the database used to generate the content of FIGS. 3-7 may be based on database entries corresponding to over 18278 total players (e.g., including men, women, and youth players). More specifically, the content of FIGS. 3-7 may be created based on filtering the available data between Jan. 1, 2019 and Feb. 28, 2024 (e.g., based on approximately 3811 players since 2019, minimum balls faced/bowled=400). Player vs player comparison may be made for players who have played in an overlapping time period.

In addition, the player cards (e.g., 600, 610, 700, 710, and 720) may include category specific player ratings. For example, a user may wish to filter the player ratings by one or more categories. The user may select one or more categories (e.g., dry grass pitch) and based on the selected one or more categories, the system may determine and generate one or more player ratings related to the one or more selected categories.

In addition, the player cards (e.g., 600, 610, 700, 710, and 720) may include a comparison view between two or more players. For example, a user may wish to compare bowlers for an upcoming match. The user may select a bowler for each team and based on the selected players, the player card (e.g., 600) may present a set of player ratings comparing each player for the identified match. The player card may include generated and/or predicted player ratings related to the types of bowls, number of strikes, average number of bowls, or the like.

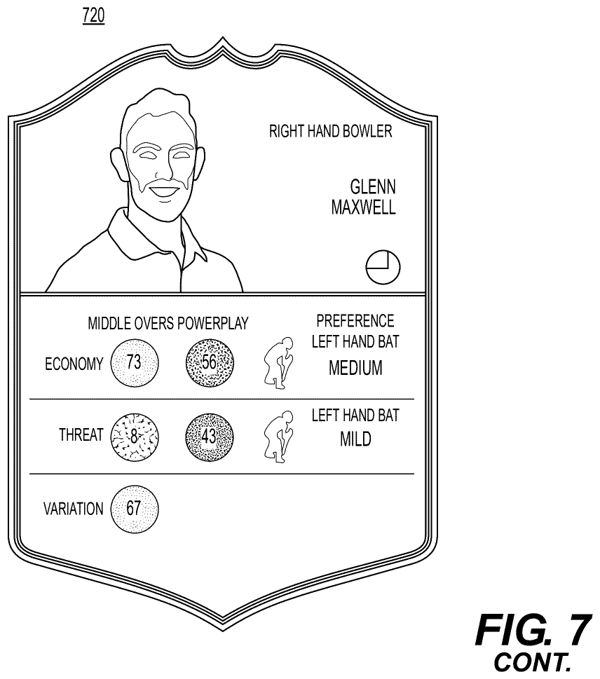

FIG. 8 depicts a flow diagram for training a machine-learning model, according to one or more aspects of the disclosed subject matter. As shown in flow diagram 800 of FIG. 8, training data 812 may include one or more of stage inputs 814 and known outcomes 818 related to a machine learning model to be trained. The stage inputs 814 may be from any applicable source including a component or set shown in the figures provided herein. The known outcomes 818 may be included for machine learning models generated based on supervised or semi-supervised training. An unsupervised machine learning model might not be trained using known outcomes 818. Known outcomes 818 may include known or desired outputs for future inputs similar to or in the same category as stage inputs 814 that do not have corresponding known outputs.

The training data 812 and a training algorithm 820 may be provided to a training component 830 that may apply the training data 812 to the training algorithm 820 to generate a trained machine learning model 850. According to an implementation, the training component 830 may be provided comparison results 816 that compare a previous output of the corresponding machine learning model to apply the previous result to re-train the machine learning model. The comparison results 816 may be used by the training component 830 to update the corresponding machine learning model. The training algorithm 820 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 800 may be a trained machine learning model 850.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

### Machine Learning for Team/Player Predictions

According to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The system described herein may include a machine-learning model including a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive text as input, and generate a response in real-time.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to): the nodes containing the previous states of the player along the time-series; and the state nodes of the other players, team and the current game state in the current time-step. It may not be necessary for the nodes to be homogeneous—beyond having the same feature dimension—and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernouilli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

### Sports Machine Learning

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data. Machine Learning Models.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

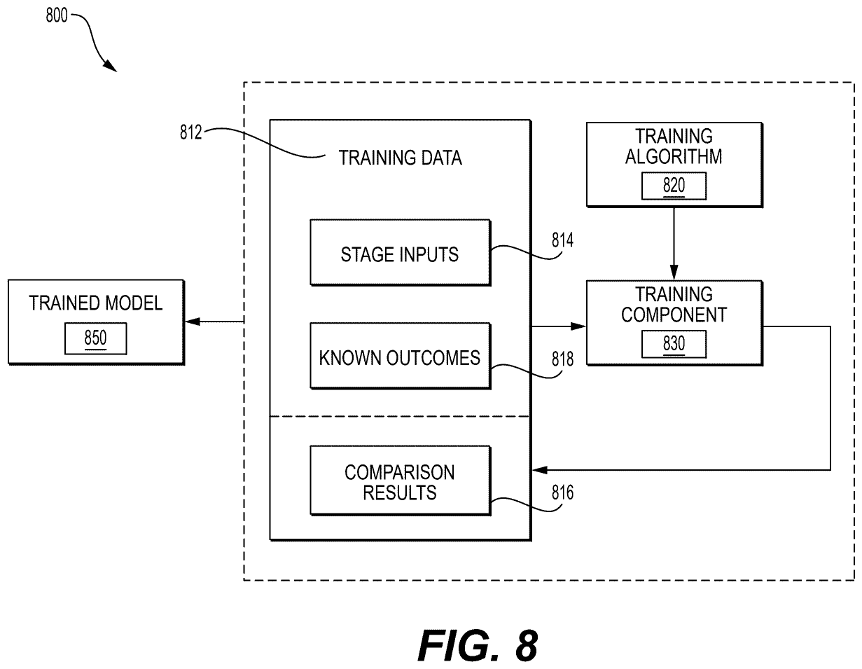

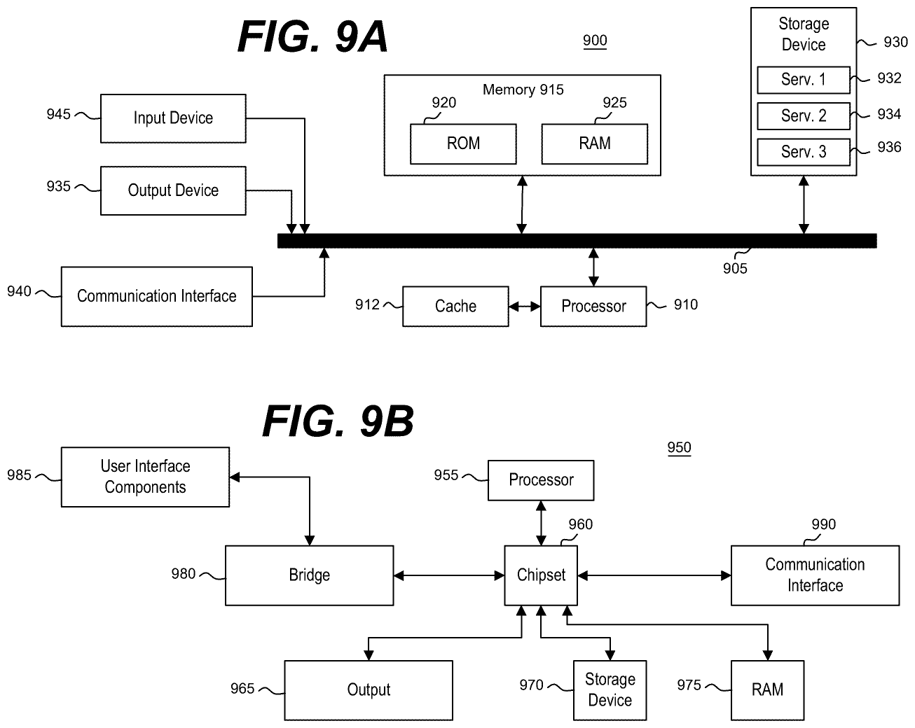

FIG. 9A illustrates an architecture of computing system 900, according to example embodiments. System 900 may be representative of at least a portion of organization computing system 104. One or more components of system 900 may be in electrical communication with each other using a bus 905. System 900 may include a processing unit (CPU or processor) 910 and a system bus 905 that couples various system components including the system memory 915, such as read only memory (ROM) 920 and random access memory (RAM) 925, to processor 910. System 900 may include a cache of high-speed memory connected directly with, in close proximity to, or integrated as part of processor 910. System 900 may copy data from memory 915 and/or storage device 930 to cache 912 for quick access by processor 910. In this way, cache 912 may provide a performance boost that avoids processor 910 delays while waiting for data. These and other modules may control or be configured to control processor 910 to perform various actions. Other system memory 915 may be available for use as well. Memory 915 may include multiple different types of memory with different performance characteristics. Processor 910 may include any general purpose processor and a hardware module or software module, such as service 1 932, service 2 934, and service 3 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction with the computing system 900, an input device 945 may represent any number of input mechanisms, such as a microphone for speech, a touch-sensitive screen for gesture or graphical input, keyboard, mouse, motion input, speech and so forth. An output device 935 (e.g., display) may also be one or more of a number of output mechanisms known to those of skill in the art. In some instances, multimodal systems may enable a user to provide multiple types of input to communicate with computing system 900. Communications interface 940 may generally govern and manage the user input and system output. There is no restriction on operating on any particular hardware arrangement and therefore the basic features here may easily be substituted for improved hardware or firmware arrangements as they are developed.

Storage device 930 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 925, read only memory (ROM) 920, and hybrids thereof.

Storage device 930 may include services 932, 934, and 936 for controlling the processor 910. Other hardware or software modules are contemplated. Storage device 930 may be connected to system bus 905. In one aspect, a hardware module that performs a particular function may include the software component stored in a computer-readable medium in connection with the necessary hardware components, such as processor 910, bus 905, output device 935, and so forth, to carry out the function.

FIG. 9B illustrates a computer system 950 having a chipset architecture that may represent at least a portion of organization computing system 104. Computer system 950 may be an example of computer hardware, software, and firmware that may be used to implement the disclosed technology. System 950 may include a processor 955, representative of any number of physically and/or logically distinct resources capable of executing software, firmware, and hardware configured to perform identified computations. Processor 955 may communicate with a chipset 960 that may control input to and output from processor 955. In this example, chipset 960 outputs information to output 965, such as a display, and may read and write information to storage device 970, which may include magnetic media, and solid-state media, for example. Chipset 960 may also read data from and write data to RAM 975. A bridge 980 for interfacing with a variety of user interface components 985 may be provided for interfacing with chipset 960. Such user interface components 985 may include a keyboard, a microphone, touch detection and processing circuitry, a pointing device, such as a mouse, and so on. In general, inputs to system 950 may come from any of a variety of sources, machine generated and/or human generated.

Chipset 960 may also interface with one or more communication interfaces 990 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 955 analyzing data stored in storage device 970 or RAM 975. Further, the machine may receive inputs from a user through user interface components 985 and execute appropriate functions, such as browsing functions by interpreting these inputs using processor 955.

It may be appreciated that example systems 900 and 950 may have more than one processor 910 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

TABLE 1
dob,5/11/1988 0:00,22/07/1989 00:00
player,Virat Kohli,Trent Boult
batting_hand,Right,Right
bowling_hand,Right,Left
is_wicket_keeper_games_played,0,0
games_played,126,118
batting_balls_faced,3132,111
batting_total_outs,99,8
batting_total_runs,4185,140
batting_boundaries,478,16
batting_boundaries_runs,2164,82
batting_boundary_runs_perc,51.7,58.6
batting_sixes_runs_perc,18.1,38.6
batting_balls_per_six,2485.7,1233.3
wk_batting_boundary_runs_perc,51.7,58.6
batting_strike_rate,133.6,126.1
batting_average,42.3,17.5
batting_balls_faced_vs_seam,1828,77
batting_balls_faced_vs_spin,1304,34
batting_runs_vs_seam,2693,85
batting_runs_vs_spin,1492,55
batting_strike_rate_vs_seam,147.3,110.4
batting_strike_rate_vs_spin,114.4,161.8
batting_strike_rate_seam_pref,1.28759,0.68232
batting_strike_rate_spin_pref,0.77665,1.46558
batting_outs_vs_seam,70,6
batting_outs_vs_spin,29,2
batting_average_vs_seam,38.5,14.2
batting_average_vs_spin,51.4,27.5
balls_per_out,31.6,13.9
balls_per_out_vs_seam,26.1,12.8
balls_per_out_vs_spin,45,17
balls_per_out_seam_pref,0.58,0.75294
balls_per_out_spin_pref,1.72414,1.32813
batting_runs_front_foot,2789,79
batting_front_foot_perc,89,71.2
batting_attacking_shots,1705,78
batting_attacking_shots_perc,54.4,70.3
batting_defensive_shots,470,4
batting_defensive_shots_perc,15,3.6
batting_shot_type_leaves,73,2
batting_leave_perc,2.3,1.8
batting_dot_balls,920,43
batting_dot_balls_perc,29.4,38.7
batting_run_scoring_balls,2212,68
batting_run_scoring_balls_perc,70.6,61.3
batting_runs_straight_perc,24.3,42.1
batting_runs_off_perc,18.5,12.9
batting_runs_leg_perc,32.7,25.7
batting_runs_behind_perc,24.5,19.3
.batting_runs_straight_perc,24.3,42.1
.batting_runs_off_perc,18.5,12.9
.batting_runs_leg_perc,32.7,25.7
.batting_runs_behind_perc,24.5,19.3
batting_runs_drive_perc,34.8,35
batting_runs_sweep_perc,1.9,4.3
batting_runs_slog_perc,5.8,12.1
batting_runs_pull_perc,13.8,17.1
batting_runs_cut_perc,5,10
batting_runs_work_perc,37.5,21.4
batting_runs_unorthodox_perc,0.2,0
balls_bowled_inc_wides,6,2775
balls_bowled,6,2690
balls_bowled_spin,0,0
balls_bowled_seam,6,2690
balls_bowled_in_power_play,0,1579
balls_bowled_in_first_six,0,1543
balls_bowled_in_last_four_t20,6,655
bowling_runs_conceded,6,3515
bowling_boundary_conceded,0,502
bowling_boundary_runs_conceded,,2218
bowling_boundary_runs_perc,,63.1
wickets_taken,0,143
bowling_average,,24.6
bowling_average_to_right_hander,,26.3
bowling_average_to_left_hander,,21.1
bowling_strike_rate,,18.8
bowling_strike_rate_to_right_hander,,19.8
bowling_strike_rate_to_left_hander,,16.9
bowling_strike_rate_to_right_hander_pref,,1.1716
bowling_strike_rate_to_left_hander_pref,,0.85354
bowling_strike_rate_in_power_play,,21.9
bowling_strike_rate_outside_power_play,,15.6
bowling_economy,6,7.8
bowling_economy_to right hander,4,8
bowling_economy_to_left_hander,8,7.5
bowling_economy_to_right_hander_pref,0.5,1.06667
bowling_economy_to_left_hander_pref,2,0.9375
bowling_economy_in_power_play,,7.1
bowling_economy_outside_power_play,6,8.8
bowling_dot_balls,1,1205
bowling_dot_balls_perc,16.7,44.8
bowling_false_shot,0,523
bowling_false_shot_perc,0,19.4
bowling_defensive_shots,1,501
bowling_defensive_shots_perc,16.7,18.6
bowling_spin_variation_perc,,
bowling_seam_variation_perc,0,13.3
wickets_taken_vs_top_order,0,78
balls_bowled_vs_top_order,0,1596
bowling_runs_conceded_vs_top_order,0,2024
bowling_average_vs_top_order,,25.9
bowling_strike_rate_vs_top_order,,20.5
bowling_economy_vs_top_order,,7.6
wickets_taken_vs_mid_low_order,0,65
balls_bowled_vs_mid_low_order,6,1094
bowling_runs_conceded_vs_mid_low_order,6,1491
bowling_average_vs_mid_low_order,,22.9
bowling_strike_rate_vs_mid_low_order,,16.8
bowling_economy_vs_mid_low_order,6,8.2
field_position,Short Extra Cover,Mid On
catches,57,44
catches_per_match,0.45,0.37
catch_attempts,79,58
catch_success_perc,72.2,75.9
med_or_difficult_catches,19,23
med_or_difficult_catch_attempts,32,36
med_or_difficult_catch_success_perc,59.4,63.9
runs_saved,37,35
total_runs_saved,73,62
total_runs_saved_per_match,0.58,0.53
wk_catches,,
wk_catches_per_match,,
wk_catch_attempts,,
wk_catch_success_perc,,
wk_med_or_difficult_catches,,
wk_med_or_difficult_catch_attempts,,
wk_med_or_difficult_catch_success_perc,,
wk_stumping_opportunities,,
wk_stumpings,,
wk_stumpings_success_perc,,
wk_stumpings_per_match,,
byes,,
byes_per_match,,
batting_strike_rate_batting_rating,57.28476821,
batting_boundary_runs_perc_batting_rating,20.75055188,
balls_per_out_batting_rating,96.90949227,
batting_balls_per_six_batting_rating,30.90507726,
bowling_seam_variation_perc_bowling_rating,,57.65625
bowling_spin_variation_perc_bowling_rating,,
bowling_economy_bowling_rating,,63.92276423
bowling_strike_rate_bowling_rating,,51.62601626
bowling_economy_in_power_play_bowling_rating,,78.28810021
bowling_economy_outside_power_play_bowling_rating,,34.04471545
bowling_strike_rate_in_power_play_bowling_rating,,55.16483516
bowling_strike_rate_outside_power_play_bowling_rating,,69.51219512
bowling_variation_perc_bowling_rating,,57.65625
catch_success_perc_fielding_rating,17.10353866,26.08125819
byes_per_match_wicket_keeper_rating,,
batting_runs_straight_perc_batting_rating,58.05739514,
batting_runs_off_perc_batting_rating,48.67549669,
batting_runs_leg_perc_batting_rating,71.74392936,
batting_runs_behind_perc_batting_rating,31.45695364,
shot_direction_batting_preference,medium_preference_batting_runs_leg_perc_{—}
batting_rating,
batting_runs_drive_perc_batting_rating,72.29580574,
batting_runs_sweep_perc_batting_rating,5.298013245,
batting_runs_slog_perc_batting_rating,22.84768212,
batting_runs_pull_perc_batting_rating,29.91169978,
batting_runs_cut_perc_batting_rating,8.057395143,
batting_runs_work_perc_batting_rating,98.89624724,
batting_runs_unorthodox_perc_batting_rating,27.59381898,
shot_type_batting_preference,strong_preference_batting_runs_work_perc_batt
ing_rating,
batting_strike_rate_seam_pref_batting_rating,82.33995585,
batting_strike_rate_spin_pref_batting_rating,17.8807947,
strike_rate_bowler_type_batting_preference,medium_preference_batting_strik
e_rate_seam_pref_batting_rating,
balls_per_out_seam_pref_batting_rating,12.14128035,
balls_per_out_spin_pref_batting_rating,88.0794702,
balls_per_out_bowler_type_batting_preference,strong_preference_balls_per_o
ut_spin_pref_batting_rating,
bowling_economy_to_right_hander_pref_bowling_rating,,27.74390244
bowling_economy_to_left_hander_pref_bowling_rating,,72.45934959
handed_economy_bowling_preference,,medium_preference_bowling_economy_to_le
ft_hander_pref_bowling_rating
bowling_strike_rate_to_right_hander_pref_bowling_rating,,29.57317073
bowling_strike_rate_to_left_hander_pref_bowling_rating,,70.6300813
handed_strike_rate_bowling_preference,,medium_preference_bowling_strike_ra
te_to_left_hander_pref_bowling_rating

TABLE 2

Percentile Rating Columns:
batting_strike_rate:higher_better
batting_balls_per_six:lower_better
boundary_runs_perc:higher_better
balls_per_out:higher_better
bowling_economy:lower_better
bowling_strike_rate:lower_better
bowling_economy_in_power_play:lower_better
bowling_economy_outside_power_play:lower_better
bowling_spin_variation_perc:higher_better
bowling_seam_variation_perc:higher_better
bowling_variation_perc:higher_better
bowling_strike_rate_in_power_play:lower_better
bowling_strike_rate_outside_power_play:lower_better
catch_success_perc:higher_better
byes_per_match:lower_better
Shot Direction:
batting_runs_straight_perc:higher_better
batting_runs_o_perc:higher_better
batting_runs_leg_perc:higher_better
batting_runs_behind_perc:higher_better
Shot Type:
batting_runs_drive_perc:higher_better
batting_runs_sweep_perc:higher_better
batting_runs_slog_perc:higher_better
batting_runs_pull_perc:higher_better
batting_runs_cut_perc:higher_better
batting_runs_work_perc:higher_better
batting_runs_unorthodox_perc:higher_better
Strike Rate Bowler Type:
batting_strike_rate_seam_pref:higher_better
batting_strike_rate_spin_pref:higher_better
Balls per out Bowler Type:
balls_per_out_seam_pref:higher_better
balls_per_out_spin_pref:higher_better
Handed Economy:
bowling_economy_to_right_hander_pref:lower_better
bowling_economy_to_left_hander_pref:lower_better
Handed Strike Rate:
bowling_strike_rate_to_right_hander_pref:lower_better
bowling_strike_rate_to_left_hander_pref:lower_better

What is claimed is:

1. A computer-implemented method for generating an interactive player ratings card, the method comprising:
receiving, by a computing system, a plurality of event data comprising a plurality of real-time and historical player data;
extracting, by one or more machine learning models, a plurality of player metric data associated with the plurality of event data;
aggregating, by the one or more machine learning models, the plurality of player metric data to determine one or more player ratings;
generating, by the one or more machine learning models, the interactive player ratings card including the one or more player ratings; and
transmitting, by the computing system, the interactive player ratings card to a user device.

2. The computer-implemented method of claim 1, the method further comprising:
updating, by the computing system, the plurality of player metric data in response to receiving additional event data or predicted data;
generating, by the one or more machine learning models, an updated interactive player ratings card including the additional event data or predicted data; and
transmitting, by the computing system, the updated interactive player ratings card to the user device.

3. The computer-implemented method of claim 1, wherein following aggregating the plurality of metric data, the method comprises:
predicting, by the one or more machine learning models, one or more player ratings based on an upcoming event.

4. The computer-implemented method of claim 3, wherein the upcoming event includes at least one of a match, tournament, or series.

5. The computer-implemented method of claim 1, wherein the interactive player ratings cards includes one or more graphical objects associated with each of the player ratings, wherein the one or more graphical objects include at least one of a text, a graphic, or a color coding.

6. The computer-implemented method of claim 5, wherein the one or more graphical objects include a comparison between the one or more player ratings and one or more predicted player ratings.

7. The computer-implemented method of claim 1, wherein the plurality of real-time and historical player data includes at least one of a dismissal, an opposing shot blocked, a completed pass, or an interception.

8. A system for generating an interactive player ratings card, the system comprising:
a memory storing instructions and a processor operatively connected to the memory and configured to execute the instructions to perform operations including:
receiving a plurality of event data comprising a plurality of real-time and historical player data;
extracting a plurality of player metric data associated with the plurality of event data;
aggregating the plurality of player metric data to determine one or more player ratings;
generating the interactive player ratings card including the one or more player ratings; and
transmitting the interactive player ratings card to a user device.

9. The system of claim 8, the operations further comprising:
updating the plurality of player metric data in response to receiving additional event data or predicted data;
generating an updated interactive player ratings card including the additional event data or predicted data; and
transmitting the updated interactive player ratings card to the user device.

10. The system of claim 8, wherein following aggregating the plurality of metric data, the operation comprises:
predicting one or more player ratings based on an upcoming event.

11. The system of claim 10, wherein the upcoming event includes at least one of a match, tournament, or series.

12. The system of claim 8, wherein the interactive player ratings cards includes one or more graphical objects associated with each of the player ratings, wherein the one or more graphical objects include at least one of a text, a graphic, or a color coding.

13. The system of claim 12, wherein the one or more graphical objects include a comparison between the one or more player ratings and one or more predicted player ratings.

14. The system of claim 8, wherein the plurality of real-time and historical player data includes at least one of a dismissal, an opposing shot blocked, a completed pass, or an interception.

15. A non-transitory computer-readable medium storing instructions that, when executed by one or more processors, perform operations including:
receiving a plurality of event data comprising a plurality of real-time and historical player data;
extracting a plurality of player metric data associated with the plurality of event data;
aggregating the plurality of player metric data to determine one or more player ratings;
generating an interactive player ratings card including the one or more player ratings; and
transmitting the interactive player ratings card to a user device.

16. The non-transitory computer-readable medium of claim 15, the operations further comprising:
updating the plurality of player metric data in response to receiving additional event data or predicted data;
generating an updated interactive player ratings card including the additional event data or predicted data; and
transmitting the updated interactive player ratings card to the user device.

17. The non-transitory computer-readable medium of claim 15, wherein following aggregating the plurality of metric data, the method comprises:
predicting one or more player ratings based on an upcoming event.

18. The non-transitory computer-readable medium of claim 17, wherein the upcoming event includes at least one of a match, tournament, or series.

19. The non-transitory computer-readable medium of claim 15, wherein the interactive player ratings cards includes one or more graphical objects associated with each of the player ratings, wherein the one or more graphical objects include at least one of a text, a graphic, or a color coding.

20. The non-transitory computer-readable medium of claim 19, wherein the one or more graphical objects include a comparison between the one or more player ratings and one or more predicted player ratings.
